(19) United States
(12) Patent Application Publication
(10) Pub. No.: US 2014/0301595 A1
(43) Pub. Date: Oct. 9, 2014

(54) APPAREL WITH SPEAKER ASSEMBLY

(71) Applicant: Corey LaMont EGLESTON, Cola, SC (US)

(72) Inventor: Corey LaMont EGLESTON, Cola, SC (US)

(21) Appl. No.: 13/859,223

(22) Filed: Apr. 9, 2013

(51) Int. Cl. H04R 1/02

(52) U.S. Cl. CPC H04R 1/02
USPC 381/388

(57) ABSTRACT

A speaker assembly includes a speaker within a silicone speaker mesh, a foam pad, a battery holder, a PCBA (Printed Circuit Board Assembly), and wiring within heat shrink tubing, all of which may be positioned within any pre-existing baseball-style cap or other articles of clothing. The electronic components may be affixed in any suitable manner to the underside of a cap, and covered by a front inner shield and a rear inner shield, preferably made from a mesh material. The electronic components are operatively connected together so that the speaker may play a song, such as a fight song for a college sports team, a chant, or any other desired noise by pressing a button that is preferably affixed to the underside of the bill of the cap. The PCBA is pre-programmed with the desired sound, which is stored within in its memory.

### BACKGROUND OF THE INVENTION

The present invention relates generally to clothing with electronics integrated therein. More specifically, the present invention relates to hats that include a small speaker and assembly for producing pre-programmed audio, which could include music, a spoken message, or any other desired sound. It is contemplated that the speaker assembly set forth herein may also be incorporated into other articles of clothing, as well. The speaker assembly, which includes a speaker within a silicone speaker mesh casing, a foam pad, a battery holder, a PCBA (Printed Circuit Board Assembly), a button switch (or switches), and wiring within heat shrink tubing, may be positioned within any pre-existing baseball-style cap.

Heretofore, other hats have been designed with speaker systems, with varying degrees of success. U.S. patent application Ser. No. 11/809,286 discloses a hat incorporating an audio system configured to externally broadcast audio stored by the audio system. The hat includes a digital audio player such as an MP3 player or the like that is connected to speakers of the audio system. The speakers are mounted in pivoting flaps of the hat such that the flaps and thus the speakers are movable into an open position and a closed position. In the open position the speakers are positioned to externally broadcast audio and in the closed position the speakers are positioned to internally play audio for the wearer or not play audio at all. The hat also incorporates user controls for the digital audio player in the brim of the hat. The hat may also include a light system that is controlled by an integral light controller for various light effects with a user control incorporated in the brim of the hat. The light system preferably includes one or more LEDs that are mounted on a front of the hat and connected to the light controller. The light controller may be associated with the audio system to provide light effects in concert with the audio being played.

U.S. Pat. No. 7,862,194 is directed to an embodiment of a baseball style cap and stereo combination having a crown, a brim/bill, a sweatband and two amplified stereo speakers concealed within the brim/bill. The baseball-style cap combination further includes a battery holder/forehead cushion housing a battery holder concealed within an inner surface of the baseball-style cap combination by a flap. Also included are wires connecting the battery holder to an amplifier concealed within the sweatband and wires connecting the amplifier to the speakers. A stereophonic music generator sends a music signal which is provided to the amplifier by any suitable means of communication, like an audio cord or wireless by means of infrared or Bluetooth wireless technology.

U.S. Pat. No. 8,250,674 discloses musical headwear having a pocket that carries an electronic audio device. The pocket has an opening, sealable via fasteners disposed across fabric surrounding the top central portion of the opening. The electronic audio device is dropped into the open pocket and then sealed inside by fastening together the fasteners proximate the top central portion of the pocket opening. Gaps on either side of the seal are provided so that a user can touch the case of the electronic audio device, the case having a touch sensitive electronic pad that actuates the unit when momentarily touched by the user. When the unit is actuated, speakers embedded in the audio unit broadcast a song, chant, or other refrain that has bee pre-stored in the unit's digital memory. The unit is factory programmed to play one or more different programs responsive to momentary user contact with the touch pad.

However, none of the prior art includes an assembly that may be positioned within a standard, pre-existing baseball-style cap. Indeed, each of the above-referenced patents require that the hat be modified in significant ways in order to receive the audio speaker assembly. Thus, a need exists for a simple, inexpensive speaker assembly that may be easily added to a standard baseball-style cap without requiring any significant modifications to the cap itself.

### BRIEF SUMMARY OF THE INVENTION

In accordance with one aspect of the invention, a speaker assembly is provided, wherein the speaker assembly includes a speaker within a silicone speaker mesh, a foam pad, a battery holder, a PCBA (Printed Circuit Board Assembly), and wiring within heat shrink tubing, all of which may be positioned within any pre-existing baseball-style cap. The electronic components may be affixed in any suitable manner to the underside of a cap, and covered by a front inner shield and a rear inner shield, preferably made from a mesh material. The electronic components are operatively connected together so that the speaker may play a song, such as a fight song for a college sports team, a chant, or any other desired noise by pressing a button that is preferably affixed to the underside of the bill of the cap. The PCBA is pre-programmed with the desired sound, which is stored within in its memory.

In one embodiment, the assembly may also include a series of LED lights, which are operatively connected to the system so that the lights may flash in concert with the music or sounds emanating from the speaker.

The assembly is designed to be added to a standard, pre-existing baseball-style cap, and may be used as a part of a theme. For instance, the cap may include the colors and logos of a sports team, such as the University of South Carolina Gamecocks, and the PCBA may be programmed to play the USC fight song, or the like. It should be understood that although the speaker assembly is described herein as being primarily used in connection with baseball-style caps, it may also be incorporated into other types of hats or other articles of clothing.

### BRIEF DESCRIPTION OF THE DRAWINGS

These and other features, aspects, and advantages of the present invention will become better understood with regard to the following description, appended claims, and accompanying drawings where:

FIG. 1 is a front perspective view of a baseball style cap having a speaker assembly attached thereto in accordance with one aspect of the present invention;

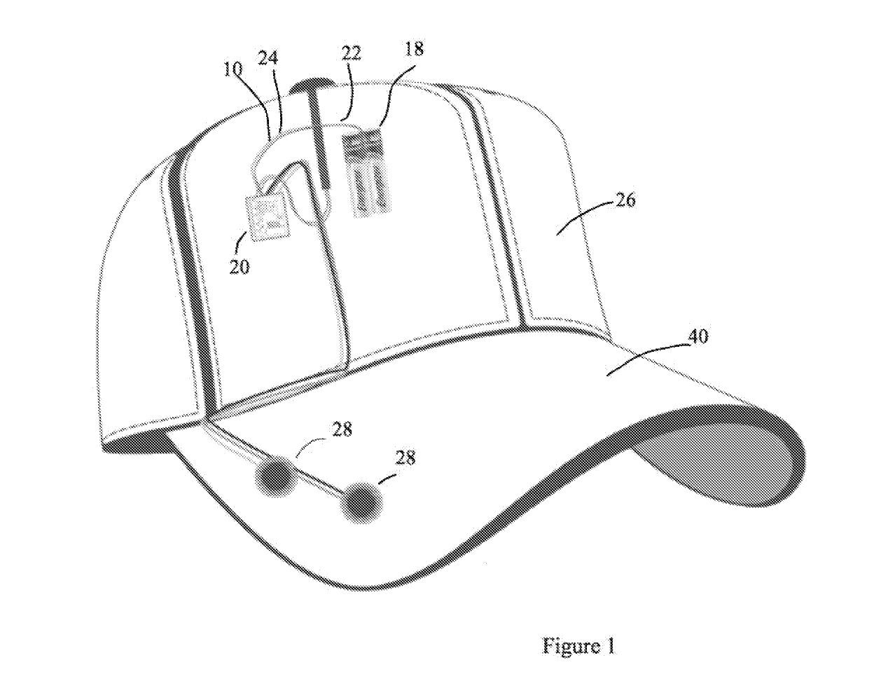

FIG. 2 is a rear view of a baseball style cap having a speaker assembly attached thereto in accordance with one aspect of the present invention;

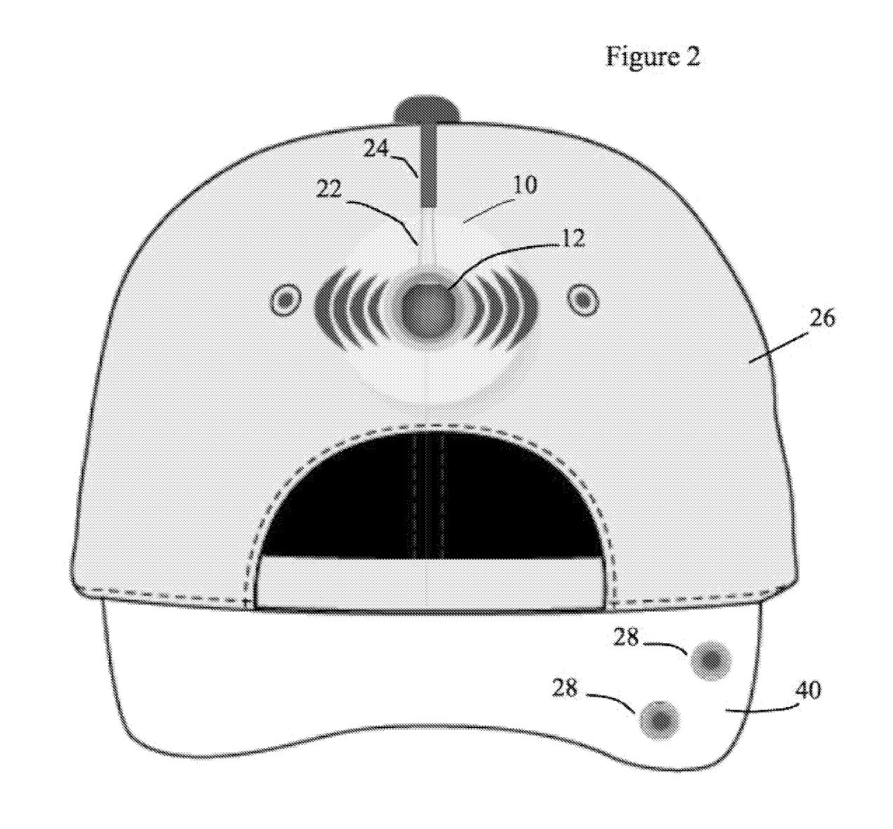

FIG. 3 is a perspective exploded view of a baseball style cap having a speaker assembly attached thereto in accordance with one aspect of the present invention;

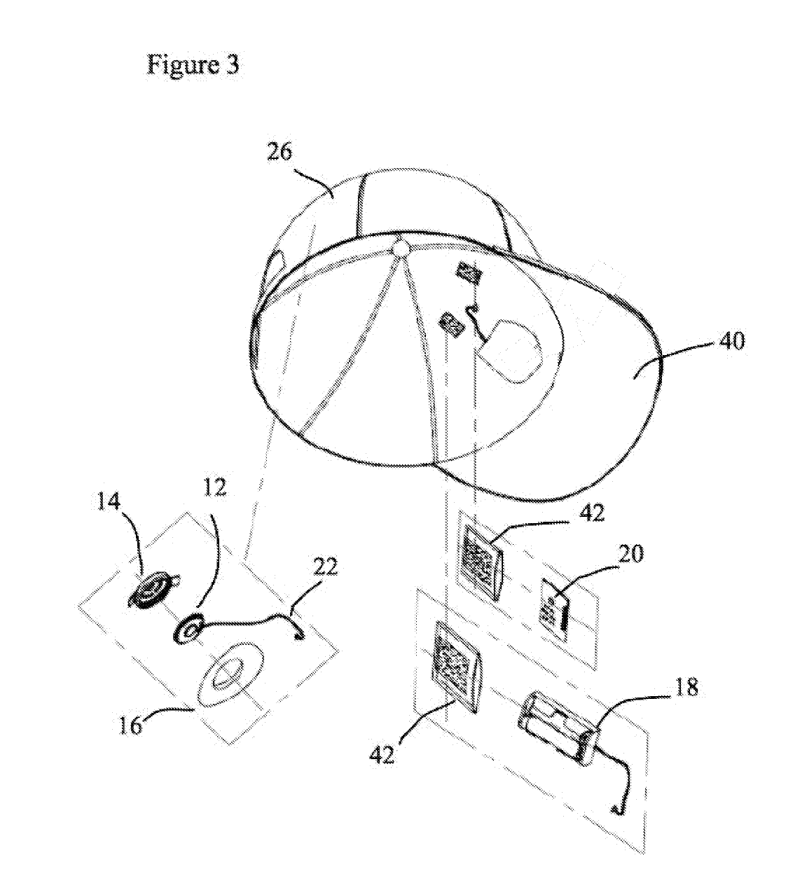

FIG. 4 is a perspective exploded view of a baseball style cap having a speaker assembly attached thereto in accordance with one aspect of the present invention, specifically showing the button switches attached to the bill of the cap and the wiring for the button switches;

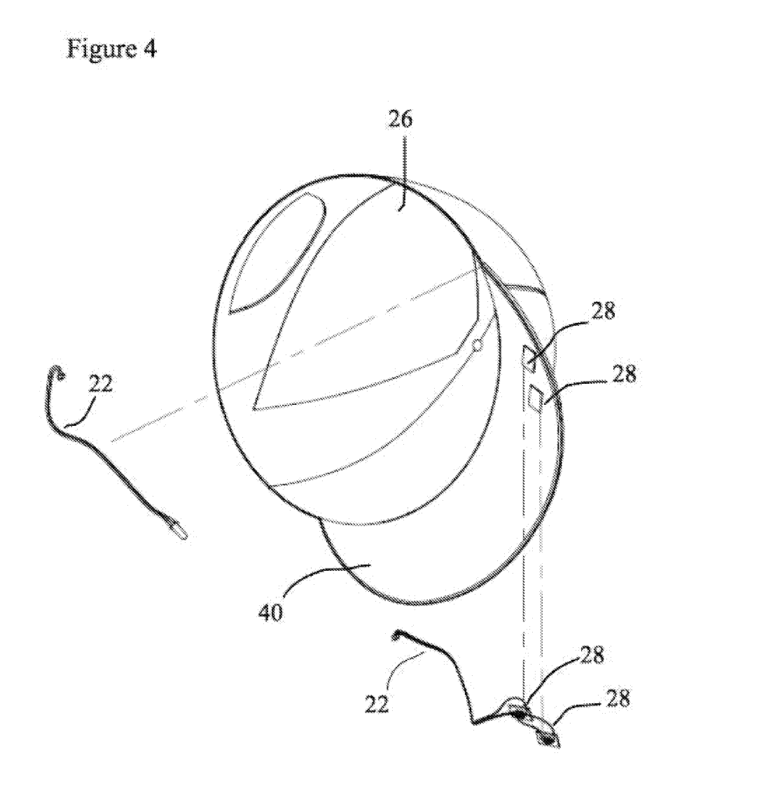

FIG. 5 is a bottom perspective view of a baseball style cap having a speaker assembly attached thereto in accordance with one aspect of the present invention;

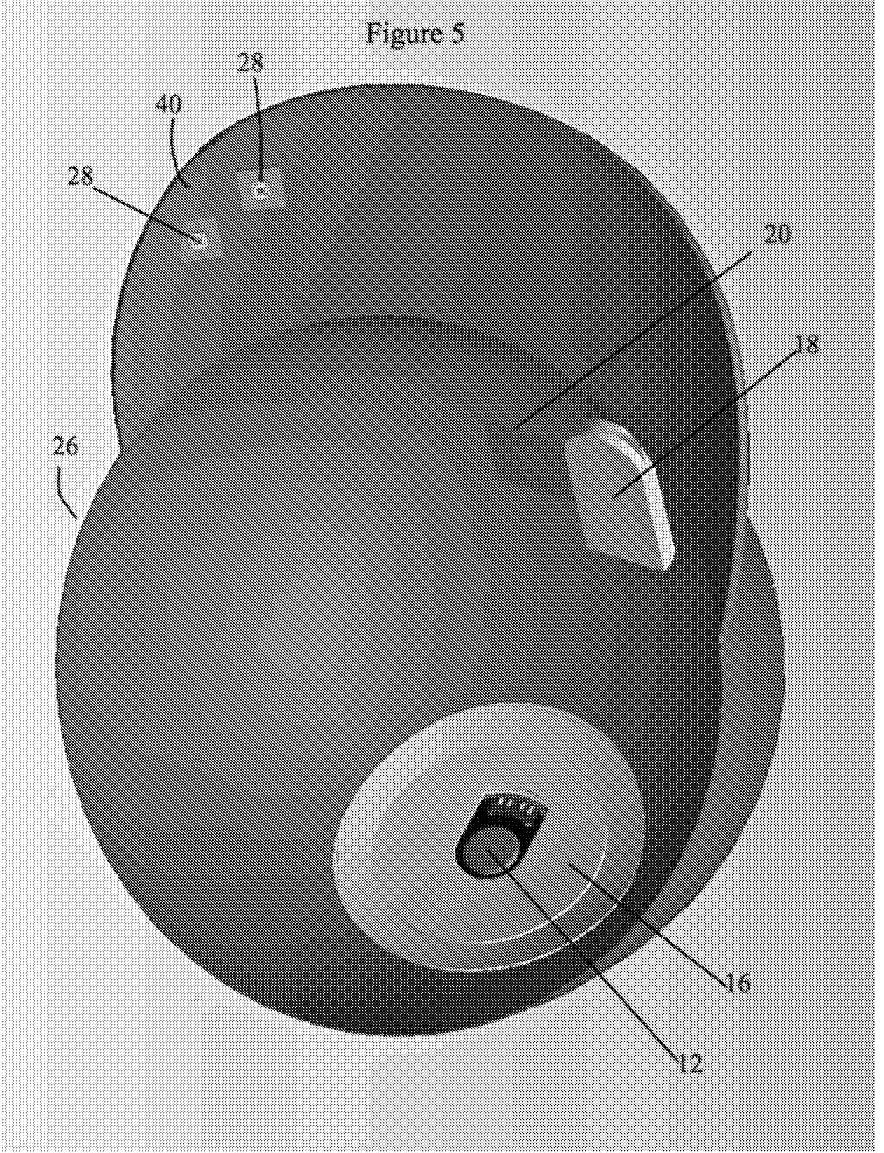

FIG. 6 is a front view of one embodiment of a PCBA, which may be used as a component of one embodiment of a speaker assembly in accordance with one aspect of the present invention;

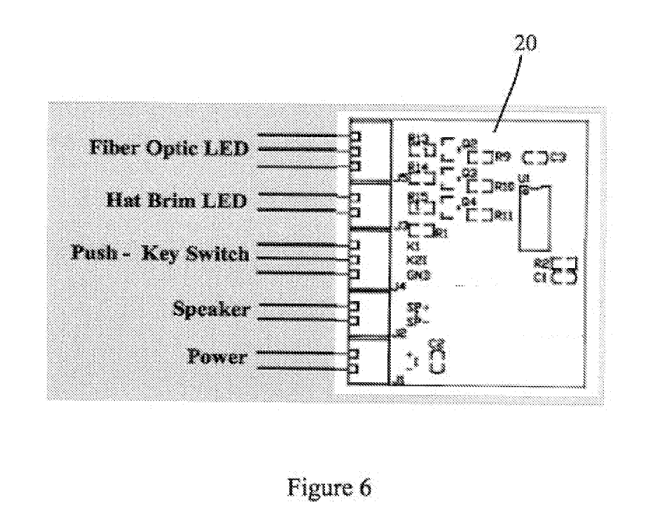

FIG. 7 is a perspective view of a speaker having a silicone casing fitted about an outer portion thereof, in accordance with one aspect of the present invention;

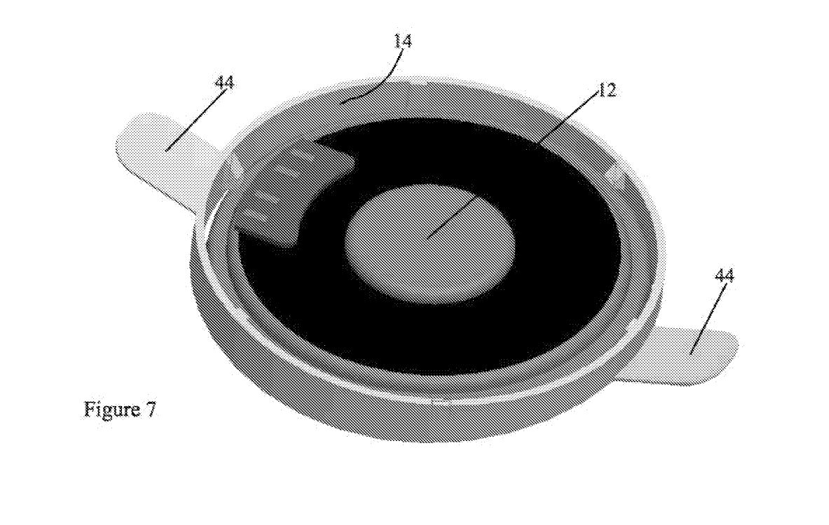

FIG. 8 is a perspective view of a speaker having a silicone casing fitted about an outer portion thereof, and further including a foam pad attached to the silicone casing, in accordance with one aspect of the present invention;

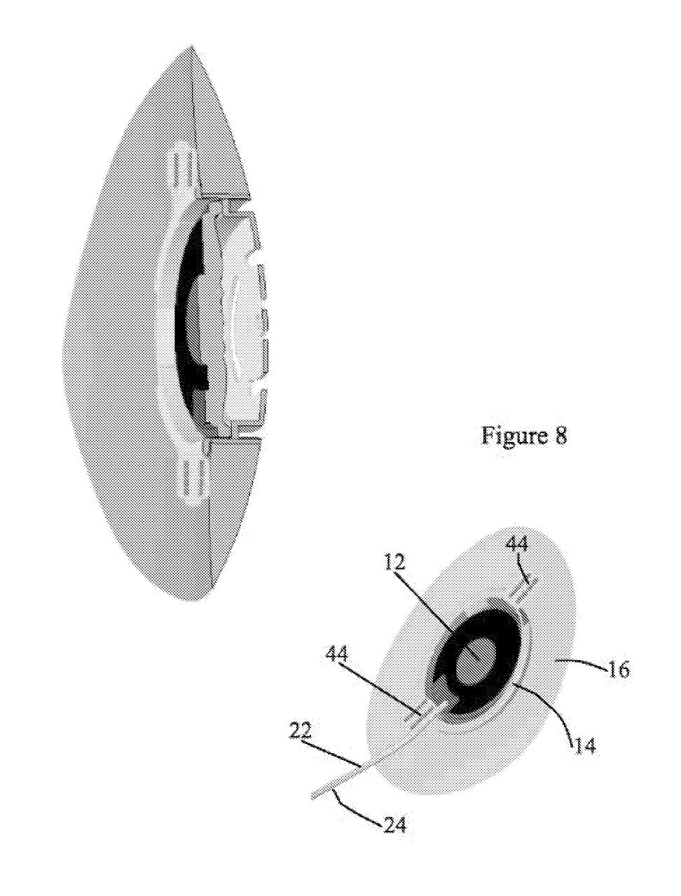

FIG. 9 is a top view of a silicone casing adapted to be received by a speaker, wherein the silicone casing includes a pair of tabs for attachment to a garment in accordance with one aspect of the present invention;

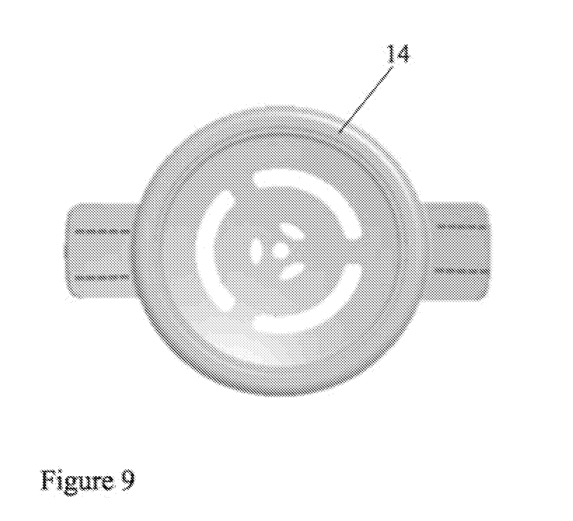

FIG. 10 is a bottom view of a baseball style cap having a speaker assembly attached thereto in accordance with one aspect of the present invention, wherein a front inner shield and a rear inner shield are attached thereto;

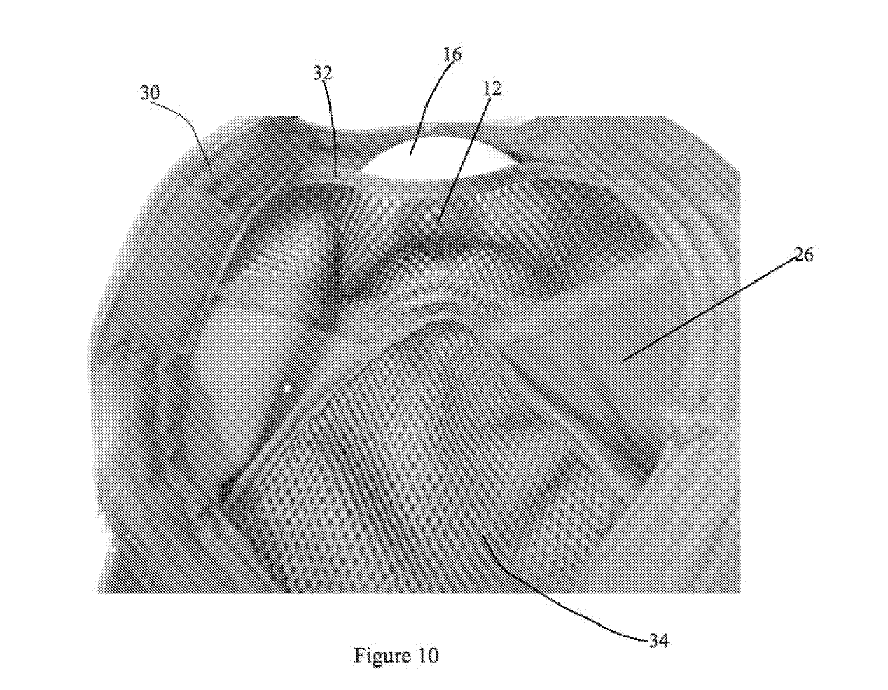

FIG. 11 is a front view of a shirt having a speaker assembly attached thereto in accordance with one aspect of the present invention;

FIG. 12 is a front view of a hooded sweatshirt having a speaker assembly attached thereto in accordance with one aspect of the present invention;

FIG. 13 is a rear view of a hooded sweatshirt having a speaker assembly attached thereto in accordance with one aspect of the present invention;

FIG. 14 is a perspective view of a wristband having a speaker assembly attached thereto in accordance with one aspect of the present invention; and

FIG. 15 is a perspective view of a belt having a speaker assembly attached thereto in accordance with one aspect of the present invention.

### DETAILED DESCRIPTION OF THE INVENTION

In accordance with one aspect of the invention, a speaker assembly 10 is provided, wherein the speaker assembly 10 includes a speaker 12 within a silicone speaker mesh casing 14, a foam pad 16, a battery holder 18, a PCBA (Printed Circuit Board Assembly) 20, and wiring 22 within heat shrink tubing 24, all of which may be positioned within any pre-existing baseball-style cap 26. In a preferred embodiment, the speaker 12 is positioned within the silicone speaker mesh casing 14, and is attached to the underside of the cap 26 in a rear portion thereof, adjacent and below the crown of the cap 26, so that the speaker portion is directed outwardly through the fabric of the cap 26. The silicone mesh casing 14 may include a pair of tabs 44 that may be used as a point of attachment for stitching the silicone mesh casing 14 to the underside of a cap 26 or other article of clothing. A foam pad 16 may be inserted over the rear portion of the speaker 12, so that the foam pad 16 is disposed between the speaker 12 and the head of a wearer, when the cap 26 is in place on a wearer's head. The speaker 12 is operatively connected via wires 22 to the PCBA 20, the button switch(es) 28, and the battery holder 18. The battery holder 18 is preferably positioned on an underside of the cap 26 on a front portion thereof, adjacent a wearer's forehead when the cap 26 is in position on a wearer's head, and the PCBA 20 may be positioned adjacent the battery holder 18. The wiring 22 may be positioned within heat shrink tubing 24, and may run from the speaker 12, down into the sweatband 30 of the cap 26, which is positioned around the inner bottom periphery of the cap 26, and then back up to the battery holder 18 and the PCBA 20. A rear inner shield 32, preferably comprising a mesh insert, may be affixed to the rear underside of the cap 26, in order to contain the speaker 12 and wiring 22 underneath, so that the rear inner shield 32 is positioned between a wearer's head and the electronics when the cap is in position on a wearer's head. Similarly, a front inner shield 34, also preferably made from the same mesh fabric as the rear inner shield 32, may be positioned in an underside front portion of the cap 26. The rear and front inner shields 32, 34 may be sewn into the cap 26, may be removable, or may be partially sewn in as flaps, to allow access thereunder.

In one embodiment, the speaker assembly 10 may include a series of LED lights 36 that are positioned about the cap 26 in desired positions, and are affixed to the underside of the cap 26 in such a way as to be visible from the outside of the cap 26. In this embodiment, the LED lights 36 are operatively connected to a fiber optic illuminator 38, which is wired to the PCBA 20 and powered by the battery holder 18 and batteries. These components, similarly, are attached to the underside of the cap 26 and covered by the either the rear or front inner shields 32,34, or both, depending on the desired location of the lights 36. The LED lights 36 may be placed on an underside of the cap 26, where each light 36 corresponds to a small hole in the cap 26, so that the light 36 shines through the hole. Any desired means of attachment may be used to attach the LED lights 36 to the cap 26, including stitching, hook and loop fasteners, adhesives, or any other suitable means, as desired.

In a preferred embodiment, the button switches 28 are positioned on the underside of the bill 40 of the cap 26 on one side thereof, and wired to the rest of the assembly. The wires 22 may be positioned beneath the fabric covering the bill 40 of the cap 26, so that the wires 22 are not exposed in an unsightly manner. A first button switch 28, once pressed, will actuate the speaker assembly 10 to play the pre-recorded sound from the PCBA 20, and will deactivate after the pre-recorded sound is finished. When the user wishes to play the sound again, he or she simply presses the first button 28 again. In the embodiment that includes the LED lights 36, a second button switch 28 is preferably used. The second button switch 28 acts an on/off button to actuate the fiber optic illumination component. In other words, the second button switch 28 turns on and off the LED lights 36.

Other components may be used with the speaker assembly, as well. A fabric pocket 42 may be provided, which may be adapted to receive the battery holder 18, and another fabric pocket 42 may be used to hold the PCBA 20. Each of these pockets 42 may include a Velcro or hook and loop attachment on an outer surface thereof, in order to secure the pocket 42 to the inside portion of the cap 26, or to any other garment or article of doting.

For purposes of assembly, the batteries are inserted into the battery holder 18, which may then be inserted in the battery holder pocket 42, if desired. The silicone speaker mesh casing 14 is stitched or otherwise attached to the underside of the cap 26, in a desired location. The speaker 12 is inserted into the silicone speaker mesh casing 14, and the speaker foam pad 16 is fitted onto the silicone speaker mesh casing 14 until it is secured thereon. The speaker wire 22 is then inserted into the heat shrink tubing 24, which is then heated in order to make it shrink down onto the speaker wire 22. The speaker wire 22, in a preferred embodiment, is then run through the sweatband 30 around the inner periphery of the cap 26. The rear inner shield 32 is stitched or otherwise attached to the inside of the cap 26, to cover the speaker 12 and adjacent components. The battery holder pocket 42 is attached to a corresponding hook and loop fastener, which is preferably affixed onto the front left underside of the cap 26. The battery holder 18 is connected to the speaker 12, the button switches 28 and the LED lights 36, together with the fiber optic illuminator 38 and the PCBA 20. The PCBA 20, within the pocket 42, is attached to a hook and loop fastener, which is preferably located on the front right underside of the cap 26. The front inner shield 34 is stitched or otherwise attached to the underside of the cap 26 on a front portion thereof, so that it covers the PCBA 20, battery holder 18, and other components positioned on the front underside of the cap 26.

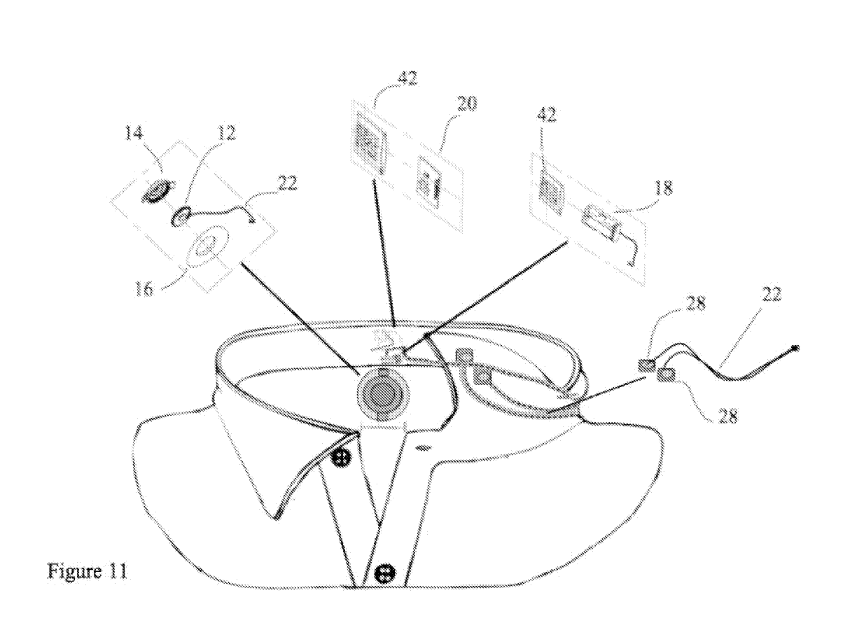

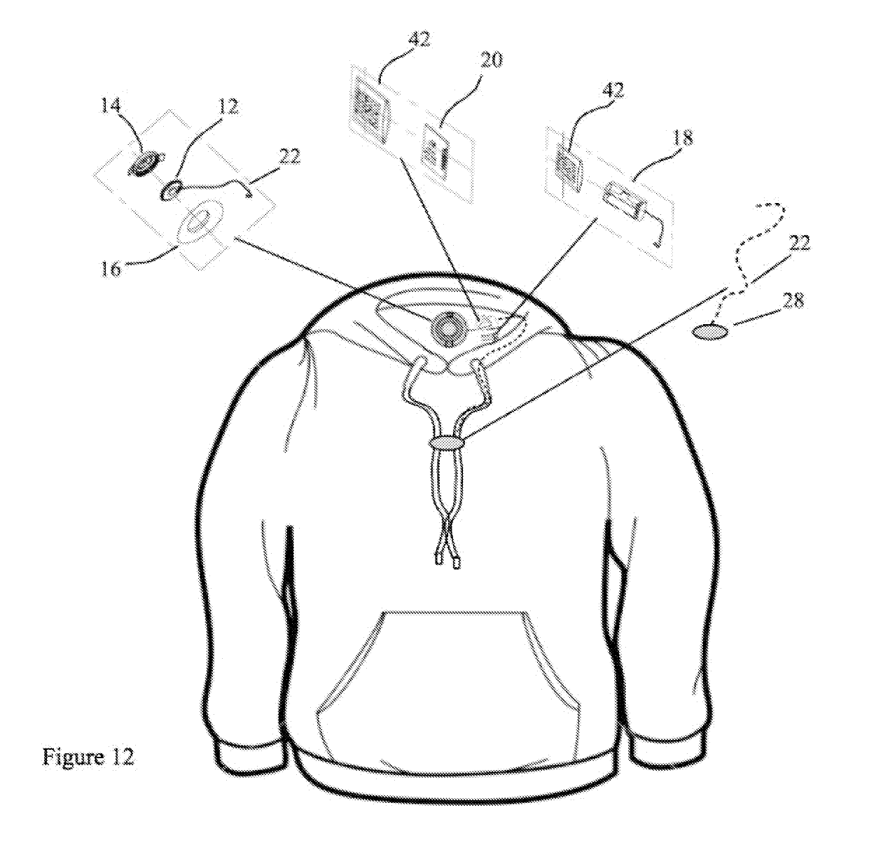

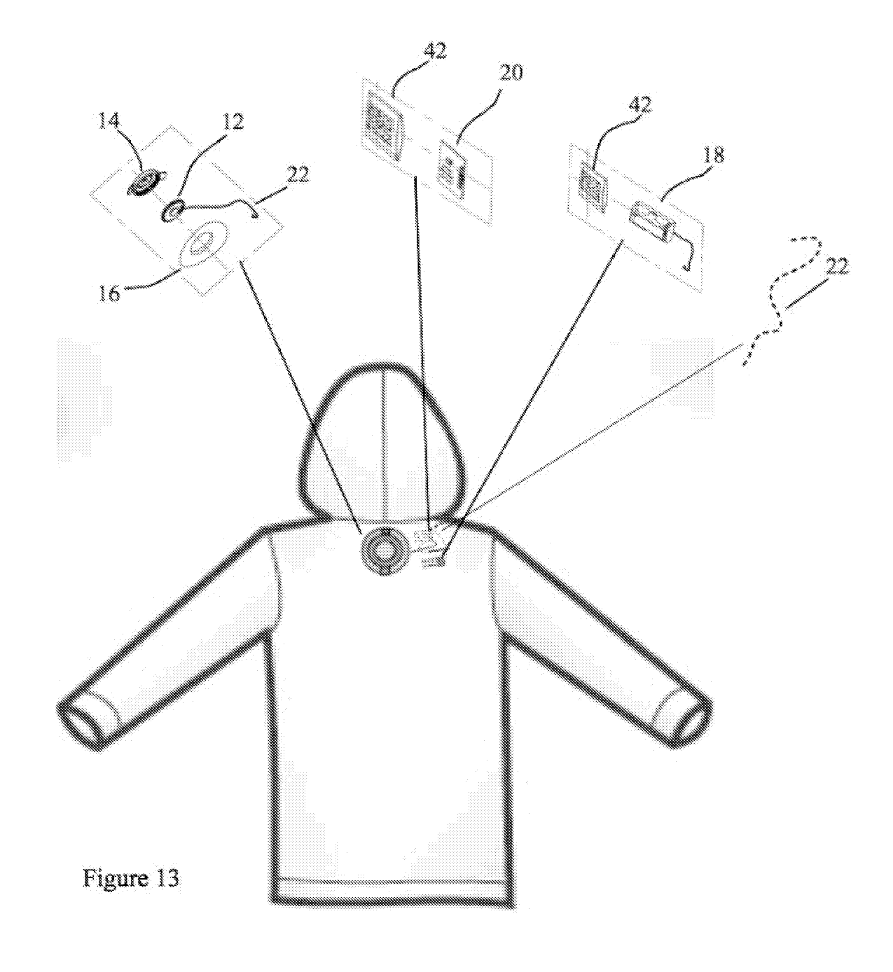

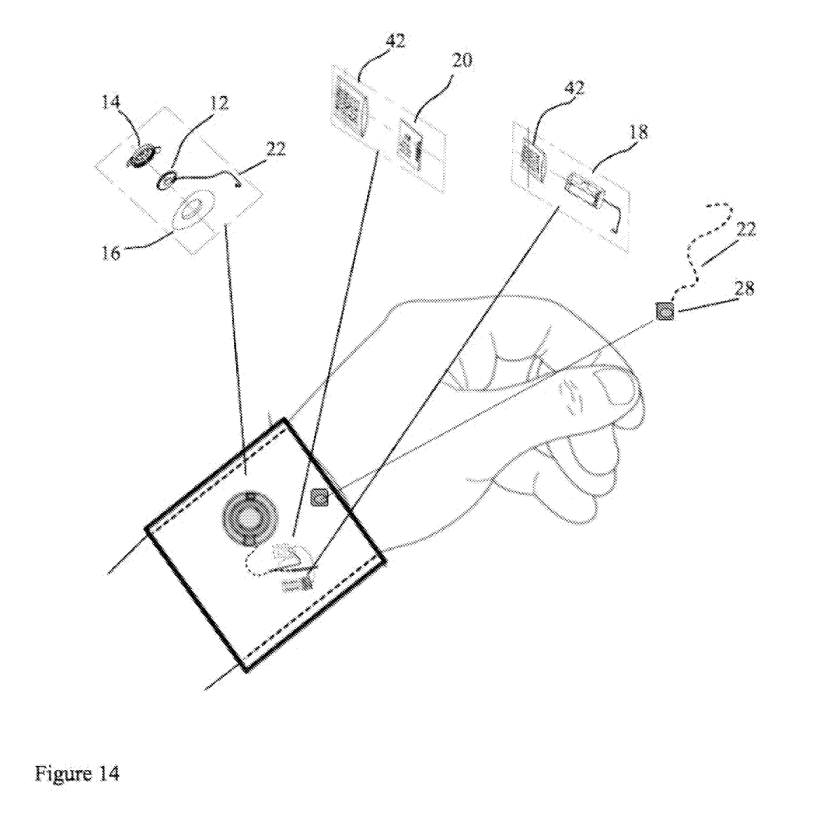

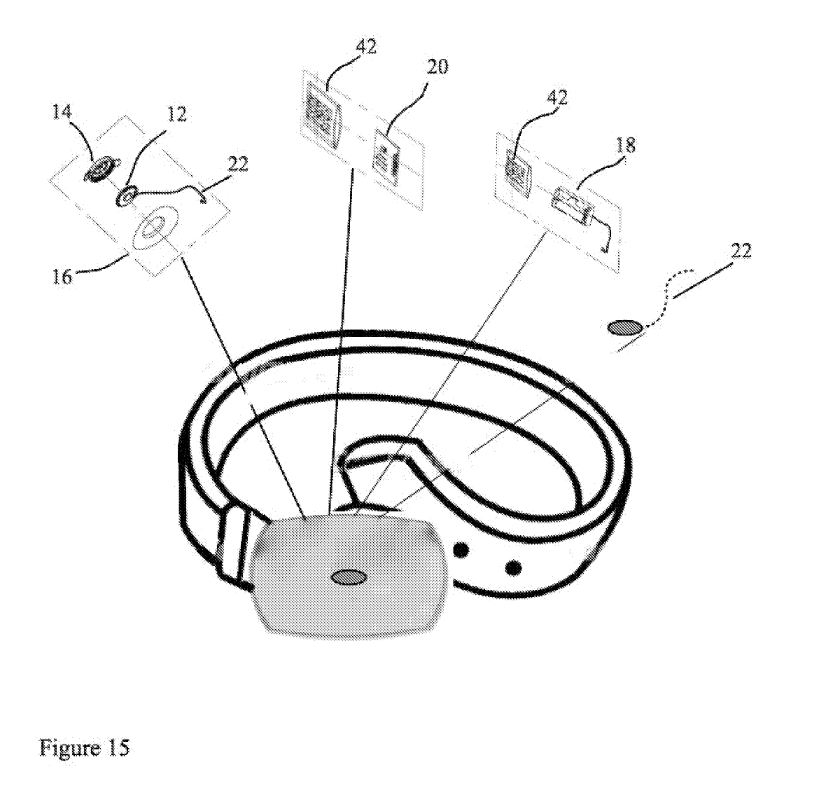

FIGS. 11-15 show different embodiments of the speaker assembly attached to various garments, including shirts, sweatshirts, wristbands and belts. FIG. 11 shows one embodiment of the speaker assembly 10 attached to a collared shirt, wherein the speaker 12, silicone casing 14 and foam pad 16 are positioned on a rear portion thereof, adjacent the collar, while the PCBA 20 (within a pocket 42) and battery holder 18 (within a pocket 42) are positioned on a backside thereof, beneath the collar. The button switches 28 are positioned on a front portion of the collar, and it is contemplated that the button switches 28 may face outwardly from the collar or inwardly. FIGS. 12 and 13 show another embodiment, wherein the speaker assembly is attached to a hooded sweatshirt. In this embodiment, the speaker 12, silicone casing 14 and foam pad 16 are positioned on a rear portion thereof, positioned beneath the hood, and the other components are positioned adjacent the speaker. FIG. 14 shows another embodiment, wherein the speaker assembly 10 components are all attached to a wristband, and FIG. 15 shows yet another embodiment, wherein the speaker assembly 10 is attached to the buckle of a belt, and the button switch is positioned on the front of the belt buckle, as shown.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A cap and speaker assembly comprising:
a baseball-style cap having a crown and a bill;
a speaker assembly comprising a speaker with wires attached to said speaker, a battery holder operatively connected to said speaker via said wires, a PCBA operatively attached to said speaker and said battery holder, and at least one button switch operatively attached to said battery holder;
wherein said speaker is attached to an underside of said cap on a rear portion thereof, with said speaker oriented so that the sound is directed outwardly through said cap, and wherein said speaker is positioned within a silicone speaker mesh; and
wherein said PCBA is programmed to play an audio sound that is pre-recorded and stored within said PCBA when said button switch is actuated.

2. The cap and speaker assembly set forth in claim 1, further comprising a foam pad that is inserted over a rear portion of said speaker, so that said foam pad is disposed between said speaker and the head of a wearer, when said cap is in place on a wearer's head.

3. The cap and speaker assembly set forth in claim 1, further comprising a rear inner shield attached to an underside of said cap on a rear portion thereof, so that said rear inner shield covers said speaker and is disposed between said speaker and the head of a wearer, when said cap is in place on a wearer's head.

4. The cap and speaker assembly set forth in claim 1, further comprising a front inner shield attached to an underside of said cap on a front portion thereof, so that said front inner shield covers said battery holder and is disposed between said battery holder and the head of a wearer, when said cap is in place on a wearer's head.

5. The cap and speaker assembly set forth in claim 1, wherein said speaker assembly further includes a series of LED lights and a fiber optic illuminator operatively connected together and further connected to said PCBA and battery holder;
wherein said LED lights are positioned on an underside of said cap so that said LED lights may be visible on an outer portion of said cap; and
wherein said LED lights are actuated to work in concert with said sound generated by said speaker.

6. The cap and speaker assembly set forth in claim 1, wherein said button switch is positioned on an underside of said bill of said cap.

7. The cap and speaker assembly set forth in claim 1, wherein said battery holder is positioned within a fabric pocket, which is attached to an underside of said cap.

8. The cap and speaker assembly set forth in claim 1, wherein said PCBA is positioned within a fabric pocket, which is attached to an underside of said cap.

9. The cap and speaker assembly set forth in claim 1, wherein said wires are positioned within heat shrink tubing.

10. A speaker assembly that is adapted to be received by an article of clothing, said speaker assembly comprising:
a speaker;
a battery holder operatively connected to said speaker, said battery holder being disposed within a first fabric pocket;
a PCBA operatively connected to said battery holder and said speaker, said PCBA being disposed within a second fabric pocket;
said speaker being positioned within a silicone speaker mesh;
a foam pad disposed about a rear portion of said speaker and said silicone speaker mesh;
a button switch operatively connected to said battery holder for actuating said speaker; and
means for attaching said first fabric pocket, said second fabric pocket and said speaker to an article of clothing.

11. The speaker assembly set forth in claim 10, wherein the means for attaching said fabric pockets and said speaker to an article of clothing is selected from the group consisting of hook and loop fasteners and stitching.

12. The speaker assembly set forth in claim 10, further including a series of LED lights and a fiber optic illuminator operatively connected to said battery holder and said PCBA, wherein said LED lights include a means for attachment to an article of clothing.

13. The speaker assembly set forth in claim 10, wherein electrical wires are utilized to operatively connect said battery holder together with said speaker, said PCBA, and said button switch.
